(19) United States
(12) Patent Application Publication
(10) Pub. No.: US 2004/0048392 A1
(43) Pub. Date: Mar. 11, 2004

(54) Container for drying biological samples, method of making such container, and method of using same

(75) Inventor: Geoffrey L. Kidd, Germantown, MD (US)

Correspondence Address: KLARQUIST SPARKMAN, LLP, 121 S.W. SALMON STREET, SUITE #1600, ONE WORLD TRADE CENTER, PORTLAND, OR, 97204-2988, US

(73) Assignee: The Gov't of the U.S.A as represented by the secretary of the Dept.of Health and Human Services

(21) Appl. No.: 10/238,147

(22) Filed: Sep. 9, 2002

(51) Int. Cl. G01N 1/22; G01N 1/18

(52) U.S. Cl. 436/178; 436/174; 436/177; 436/181; 422/99; 422/101; 422/102; 422/942; 422/948; 435/288.4

(57) ABSTRACT

Methods for venting or drying (e.g., lyophilizing) samples contained in a multi-well plate. One method involves providing a multi-well plate that includes wells that each contain a sample and define an opening substantially sealed with a filter element that permits permeation of at least one gas and substantially prevents permeation of microbes. Another variant includes introducing a sample into a well via an opening defined by the well, covering at least a portion of the well opening with a filter element, and permitting gas to enter or exit the well substantially only through the filter element. An assembly is also described that includes a multi-well plate and a sheet defining a plurality of caps, wherein each of the caps includes a microbe-impermeable filter element. Another multi-well plate assembly includes a filter positioned to extend across at least a portion of the well opening.

### TECHNICAL FIELD

The present disclosure relates to sterile containers for drying samples, and related methods. More particularly, the present disclosure relates to multi-well plates and methods of using the same.

### BACKGROUND ART

It is often desired to dry biological samples in order to preserve their shelf life and activity. One drying technique is lyophilization, which is a commonly employed freeze-drying technique. Still other biological materials, such as long chain DNA molecules and cell components, are desired to be dried at a temperature above 0° C., i.e., above freezing, in order to prevent their destruction by the forces of freezing. Inasmuch as the present disclosure is not limited to lyophilization, drying above and below the freezing point are discussed interchangeably.

Usually, after a lyophilization process is completed the freeze-dried compound is stored in a freezer, e.g., at −70° C., although lyophilization can sometimes obviate the need for freezing all together. For example, according to the manufacturer's product profile sheet, Endothelial Cell Growth Supplement (ECGS) is stable for at least 18 months when stored at 4° C. in lyophilized form, but only one month when stored in a solubilized form at −20° C.

Lyophilization of compounds is particularly useful when growing cells in a culture medium where the lyophilized compounds include peptides or growth factors. These compounds are generally provided in minute quantities due to their expense and/or potency, and they are usually extremely perishable. Lyophilization is observed to extend their shelf life.

Typically, lyophilization is carried out in a centrifugal apparatus, such as a Speed-Vac® centrifuge. The Speed-Vac® is placed in a vacuum chamber. The sample is placed in a microcentrifuge tube which is a small plastic tube (0.5, 1, or 2 mLs) typically tapered, conical or rounded, and closed at one end. Because the vacuum used in lyophilizing is extremely high (e.g., 50-500 milli-Torr), some of the liquid in the microcentrifuge tube vaporizes immediately and forces out much of the remaining solution from the tube. By applying a centrifugal force, the liquid is pushed down to the bottom of the tube in an effort to prevent the liquid from jetting out when the liquid gasifies. After lyophilization is complete, the vacuum is turned off, thereby allowing the vacuum chamber and the interior volume of the tube to return to ambient pressure.

In order to use stored dried compounds, they must be dissolved (if not already stored in solution), then filtered-sterilized, which filters out all living cells, dust, and other unwanted materials. The volume of the solution at this stage is small, e.g., 1 ml. After filter-sterilization, the compounds are usually distributed in aliquots, e.g., of 50 μl each, and unused aliquots are stored in a freezer. This avoids the necessity of repeatedly freezing and thawing the compounds, which shortens their shelf life.

The usual centrifical lyophilization method entails leaving the microcentrifuge tube lid open during lyophilization. After the vacuum is terminated, the lid is then closed. This method produces an unsterile sample, which must be resterilized by filter-sterilization. However, in this method, that portion of the stored sample adsorbed to the filter is lost.

Another method is to perform lyophilization in a sterile environment such as a clean room. However, this requires incurring the additional expense of maintaining a clean room environment.

Yet another method proposes sterile gas exchange through a membrane in an enclosed sterile environment, see, for example, U.S. Pat. No. 5,398,837 and a cell culture flask manufactured by Costar (catalog number 3056). However, neither of these methods is suitable for lyophilization using a centrifuge since the cell culture flasks cannot be centrifuged at high speeds. Moreover, the cell culture flasks provide a slow gas exchange between the outside environment and the cell culture being grown. Furthermore, the porosity of the membrane is such that it is permeable to gas but not to microbes, e.g., having diameters above about 0.22 μm.

Another container for holding samples is a multi-well plate. Multi-well plates typically consist of an ordered array of individual wells. Each well includes sidewalls and a bottom so that an aliquot of sample may be placed within each well. Multi-well plates, particularly microwell plates, are finding increasing use in connection with large-scale biochemical assays.

Multi-well plates can be placed in a centrifuge rotor for lyophilization of the samples. One commercially available multi-well plate (i.e., Whatman PF 77001101) includes a DNA-adsorbing filter at the bottom of each well through which liquid passes into a chamber below. The filter, however, is insufficient for air sterilization and it is not located above the sample surface. Another commercially available multi-well plate (i.e., Costar 07-200-688) is designed to allow diffusion between a solution in an upper chamber and a solution in a fluidly connected lower chamber. A semi-liquid permeable membrane is disposed between the upper and lower chambers, but the membrane is insufficient for air sterilization. Cover sheets that include caps for each individual well are also commercially available, for example, from Coming Glass.

Accordingly, a need exists for a container for a material that can be subjected to high centrifugal forces, as during a drying procedure, but which permits sterile gas exchange between the interior of the container and the external environment. Such a container need only be capable of permitting drying while preventing microbial contamination, independent of centrifugation, for those applications not requiring centrifugation.

### SUMMARY OF THE DISCLOSURE

The present invention is for a method of drying a solid, liquid, or gaseous sample containing a vaporizable material, such as when drying a solid material of a liquid solvent for the solid material. Such a method comprises providing a container containing the sample, which container defines an opening with the opening sealed substantially by a filter element (means), such as a membrane. The filter element permits permeation of the vaporizable material, e.g., gas, solid, liquid, or combination thereof, while substantially preventing permeation of microbes into the container. The drying method further entails permitting at least a portion of the vaporizable material to permeate the filter means, thereby affording at least a partial drying of the sample without substantial microbial contamination thereof.

The present invention also is for a method of venting a sample to its surroundings. As used herein, “venting” refers to permitting the contents of a container to come into contact with a gas external of the container either by permitting a gas flow into the container from outside or by permitting volatile components within the container to pass into the external environment. Such venting method entails providing a container having an opening sealed substantially with a filter means, which permits permeation of at least one gas and substantially prevents permeation of microbes. Preferably, the container is configured to withstand a high speed centrifugation of 50 or more times the force of gravity, and permits the gas to enter or exit the container by permeating through the filter means. Such method thereby affords venting of the sample in the container without substantially contaminating the sample with microbes.

One variant of the venting method involves venting samples contained in a multi-well plate. The method includes providing a multi-well plate that includes a plurality of wells that contain a sample that includes vaporizable material, each well defining an opening substantially sealed with a filter element, wherein the filter element permits permeation therethrough of at least one gas and substantially prevents permeation therethrough of microbes. Such permeation permits gas to enter or exit the wells, thereby affording venting of the samples without substantially contaminating the samples with microbes. The venting of the samples could achieve at least a partial drying of the samples.

A further variant of venting samples contained in a multi-well plate includes introducing a sample into a well of a multi-well plate via an opening defined by the well, covering at least a portion of the well opening with a filter element that is secured to the multi-well plate, and permitting gas to enter or exit the well substantially only through the filter element during drying or processing of the samples.

A container assembly aspect of the invention comprises a container having a closed end and an open end, which defines an interior volume therein, with the container capable of withstanding centrifugation at about 50 or more times the force of gravity. The container assembly also comprises a cap having an open position and a closed position for sealing the open end of the container, which cap carries a microbe-impermeable filter means that permits gas flow into the interior volume from external the container and permits gas flow out from the interior volume.

Relatedly, a container assembly is also contemplated which comprises a container having a closed end and an open end that defines an interior volume therein, where the container is shaped to conform to the shape of a centrifuge rotor or bucket. The container assembly also comprises a cap having an open position and a closed position for sealing the open end, with the cap including a microbe-impermeable filter means as described hereinabove.

In a preferred embodiment an instant container is provided as a microcentrifuge tube. In another embodiment, the container can be a centrifuge bottle, which conforms either to a bucket that hooks onto a centrifuge rotor or conforms to a well provided in the rotor of the centrifuge. Such a centrifuge bottle usually has a capacity of 100 mL or greater, and has a flat bottom supported by the well or bucket into which it is placed.

Multi-well plate assemblies are also disclosed. For example, there is described an assembly that includes a multi-well plate and a sheet defining a plurality of caps. The multi-well plate defines a plurality of wells that each define an opening and an interior volume. Each of the caps in the sheet includes a microbe-impermeable filter element that can allow gas flow into the interior volume from external the multi-well plate and that can allow gas flow out from the interior volume. Another multi-well plate assembly includes a filter positioned to extend across at least a portion of the well opening, wherein the filter is microbe-impermeable and gas permeable.

Also contemplated is a method of making a container assembly, and associated cap, of the invention which entails providing a cap which defines an aperture therein, covering the entire aperture with a filter means that does not permit substantial permeation of materials having a diameter of at least about 0.2 microns, and securing the filter means to the cap with an adhesive, a cement, a welding, or a mechanical fastening.

Still other objects and advantages of the present disclosure will become apparent to those skilled in the art from the following detailed description, wherein only preferred embodiments are shown and described. Accordingly, the drawings and description are to be regarded as only illustrative in nature, and not as limiting.

### BRIEF DESCRIPTION OF THE DRAWINGS

FIG. 1 depicts a side cross-sectional view of a centrifuge tube according to a first embodiment of the present invention with the cap in the open position.

FIG. 2 is a cross-sectional view of the centrifuge tube of FIG. 1 with the cap in the closed position.

FIG. 3 is a top view of the centrifuge tube of FIG. 2 according to a first embodiment of the invention.

FIG. 4 is a top view of the centrifuge tube of FIG. 2 according to a second embodiment of the present invention.

FIG. 5 is a side cross-sectional view of a centrifuge tube which includes a cover according to a third embodiment of the present invention.

FIG. 6 is a side cross-sectional view of a cap according to a fourth embodiment of the present invention.

FIG. 7 is a top view of a portion of a sheet of filter element-bearing caps for use with a multi-well plate.

FIG. 8 is a side cross-sectional view of an alternative filter configuration for use with a multi-well plate.

### DETAILED DESCRIPTION OF SEVERAL EMBODIMENTS

The present invention is a method of drying, e.g., lyophilizing, a sample in a container, which sample contains a vaporizable material. A “vaporizable material” as used herein refers to a solid, liquid or gas, or combination thereof, such as an aerosol, which can enter the vapor phase. Preferably, such a vaporizable material is a solvent for one or more biological molecules, wherein it is desired to remove the solvent preferentially from the container.

Preferred samples for drying with an instant container include synthetic and natural peptides, DNA, RNA, oligonucleotides, such as PCR primers, proteins, and hybrid molecules. Also, cells and intracellular structures can be used. In some cases it will be necessary to heat the sample sufficiently to prevent it from freezing, as when the sample contains materials that would be damaged by freezing.

A container suitable for use with the present invention can be made of any material which does not react with the components placed therein and which withstands the centrifuge pressures placed upon it. Thus, a preferred tube is a disposable, polypropylene microcentrifuge tube having an attached lid, such as that known as Eppendorf Safe-Lock (™), available from Sigma Chemical Co (St. Louis, Mo.).

Another container that could be used is a multi-well plate. Multi-well test plates are well known in the art and are exemplified, for example, by those described in U.S. Pat. Nos. 3,111,489; 3,540,856; 3,540,857; 3,540,858; 4,304,865; 4,948,442; and 5,047,215.

Typically, multi-well plates are two dimensional arrays of addressable wells located on a substantially flat surface. Multi-well plates may include any number of discrete addressable wells, and the addressable wells may be of any width or depth. Common examples of multi-well plates include 96 well plates, 384 well plates and 3456 well plates. The wells usually will be arranged in two-dimensional linear arrays on the multi-well plate. However, the wells can be provided in any type of array, such as geometric or non-geometric arrays. Well volumes typically can vary depending on well depth and cross sectional area. For example, the well volume may be between about 0.1 microliters and 500 microliters. Multi-well plates with small well volumes are often referred to as “microwell” plates. Wells can be made in any cross sectional shape including, square, round, hexagonal, other geometric or non-geometric shapes, and combinations (intra-well and inter-well) thereof. The wells can be placed in a configuration so that the well center-to well-center distance can be between about 0.5 millimeters and about 100 millimeters. The wells can have a depth between about 0.5 and 100 millimeters. The wells can have a diameter (when the wells are circular) or maximal diagonal distance (when the wells are not circular) between about 0.2 and 100 millimeters.

The multi-well plate could be constructed so that a predetermined individual or groups of wells could be separated from the plate as needed. For example, scoring or a perforated delineation could be provided between individual wells or groups of wells to allow the user to easily separate the portions of the plate.

With respect to the filter means used to prevent microbe contamination of a sample placed in an instant container, it is preferably composed of a plastic, such as nylon, however, other materials may suffice. Whenever nylon is used, it is preferred to glue the nylon filter to a cap with an epoxy resin that does not dissolve the nylon. A preferred epoxy resin is fast curing, such as is available from Duro Corporation.

A filter means employed in the present invention is preferably a membrane. For example, suitable membranes available from Millipore include the following:

Durapore (polyvinylidene fluoride), pore size 0.22 μ

MF-Millipore (mixed cellulose esters), pore size 0.22 μ and smaller

Isopore Polycarbonate, pore size 0.2 μ and smaller

Suitable membranes available from Pierce Chemical (Rockford, Ill.) include:

FilterPure (nylon 66), pore size 0.2 μ

FilterPure (PTFE/polypropylene), pore size 0.2 μ

Other suppliers and membrane materials can be readily identified by the skilled practitioner without undue experimentation.

The presently disclosed centrifuge tubes, bottles or multi-well plates may include caps which have filter elements incorporated therein. The filter elements have pore sizes small enough, less than about 0.22 μ, to prevent contaminants such as microbes, dust, and other unwanted materials from being drawn into the tubes or containers as the vacuum is released, while allowing air or other gases to enter the tubes or containers during lyophilization.

The caps can be completely detachable from the centrifuge tubes, bottles or multi-well plates, or the caps can be attached to the tubes, bottles or multi-well plates by hingeable or similar connector structures. The caps can be of any conventional design in regard to the manner that they are connectable to the tubes, bottles, or multi-well plates. That is, the caps can be designed to be received in the open end of the tubes, bottles, or wells, or the caps can be designed so that the open end of the tubes, bottles or wells are received in a lower recess of the cap. Alternatively, the caps can include annular recesses (edges) defined by concentric cylindrical structures so that the open end of the tubes, bottles, or wells are received in the annular recesses and the concentric cylindrical structures straddle the open end of the tubes, bottles, or wells. It is also within the scope of the present invention to utilize caps that can be attached to the tubes, bottles, or wells by internal or external threads which cooperate with complementary external or internal threads provided on the tube, bottles, or wells.

The presently described caps are provided with one or more openings in the top thereof. One or more filter elements are positioned to extend across the openings. The filter elements can be provided on an upper or lower surface of the cap as long as it extends across the opening(s). Alternatively, the filter element can be provided within the opening.

The opening may be of any desired shape; however, the use of circular openings may be more convenient from a manufacturing standpoint. It is noted that since the openings are provided for purposes of venting, they can be quite small. In prototype devices which were successfully tested, the openings were made by piercing the caps of microcentrifuge tubes with a needle. The resulting openings were approximately 0.2-0.5 mm in diameter. There is no upper limit on how large the openings may be; however, for larger openings it may be necessary to provide support structures across the openings to support the filter elements so that they are not pulled through the openings when the vacuum is released.

In order to protect the filter element (means) or keep the opening(s) from being plugged, a cover can be provided which can be secured to the top of the cap. Such a cover can be secured to the cap in the same manner as the cap itself is secured to the tube or bottle. Otherwise, the cover can be a relatively flat element that is secured to the cap by an adhesive. The cover may also be permanently attached to the cap and include a portion which can be tom-off and removed to expose the filter element. If the cover is permanently attached to the cap it should be vented.

With respect to drying a sample using an instant container, it may be preferable to position a desiccant outside the container so as to ensure complete drying of the sample or to prevent volatile materials from reentering the container. Suitable desiccants include activated alumina, calcium chloride, silica gel, zinc chloride, and the like.

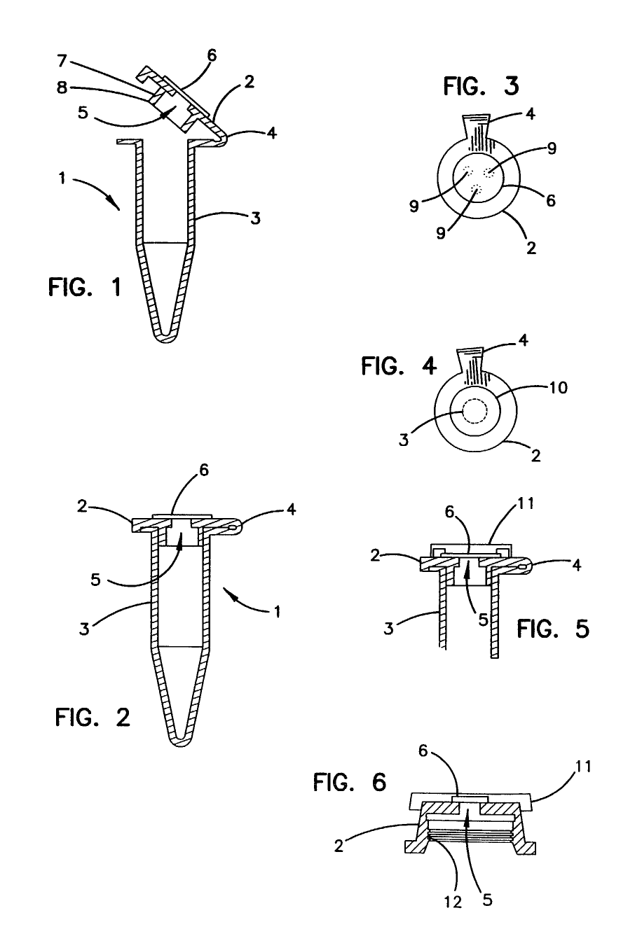

As shown in FIG. 1, a cross-sectional view of a centrifuge tube according to a first embodiment of the present invention is depicted with the cap in the open position. The centrifuge tube 1 in FIG. 1 is of conventional design except for the cap structure. Alternatively, other conventional centrifuge tubes or bottles may be provided. The cap 2, which is attached to the tube body 3 by a hinge member 4, includes an opening 5 in the cap 2. The opening 5 is covered by a filter element 6. As discussed above, the filter element 6 can be provided on either the upper or lower surface of the cap 2 as long as it extends across the opening 5. Alternatively, the filter element 6 can be provided within opening 5.

The filter element 6 can be secured to the cap 2 by an adhesive or a cement. Alternatively, the filter element 6 can be secured to the cap 2 by a welding method such as heat welding, radio frequency welding or ultrasonic welding. It is also possible to secure the filter to cap 2, or in the opening 5 of the cap 2, by means of a mechanical element such as a retaining ring or recess, to which, or by which, the filter element 6 is attached to the cap. For example, a retaining ring having a diameter larger than the filter element 6 could be placed over the filter and secured to the cap 2. Similarly, a support ring or ledge could be provided in the bore of the opening 5 and the filter element 6 could be secured either directly to the support ring or the filter element could be secured to the support ring by a retaining ring.

The centrifuge tube 1 is constructed of a material(s) that does not adversely react with the compounds which are to come into contact therewith. Such centrifuge tubes and bottles are conventional in the art. Likewise, the filter element 6 and any supporting structures, including adhesives and cements should be selected so that they do not contaminate materials they come into contact with. A preferred material for the filter element 6 is nylon. The pore size of the filter element 6 can be selected as desired to prevent contaminants from entering the centrifuge tube 1. Microcentrifuge tubes were successfully tested where the filter element had a pore size of 0.2 microns. Extending downwardly from a lower surface of cap 2 is an annular sealing portion 7 having an outwardly extending semicircular seal portion 8 at a distal end thereof.

FIG. 2 is a cross-sectional view of the centrifuge tube 1 of FIG. 1 with the cap 2 in the closed position. It is important that any filter means, or cap structure supporting the filter means seals the centrifuge tube 1 sufficiently so that contaminants, e.g. microbes, cannot be drawn into the tube except through the filter element 6 when the cap 2 is secured on the tube body 3. Accordingly, as referred to herein, such a container is said to be “substantially sealed” by the filter means. In this regard, as discussed above, the caps can be of any conventional design in regard to the manner that they are connectable to the tubes or bottles. As shown in FIG. 2, annular sealing portion 7 extends downwardly into tube 1. Seal portion provides a sterile seal along an inner surface of tube 1.

FIG. 3 is a top view of the centrifuge tube of FIG. 2 according to one embodiment of the present invention. In FIG. 3 the cap 2 is shown as including a plurality of spaced openings 9.

FIG. 4 is a top view of the centrifuge tube of FIG. 2 according to a second embodiment of the present invention. In FIG. 4 the cap 2 is shown as including a single opening 10 having a diameter larger than that of tube 1.

As discussed above, with respect to FIG. 3, the cap 2 can contain one or more openings 9 which can be of any desired shape. Since the opening(s) is/are provided for allowing gas exchange or escape as the liquid therein evaporates and for venting in air as the vacuum is released, it is sufficient to provide a single opening that is 0.2-0.5 mm in diameter. If larger openings are used, support structures can be provided across the openings to support the filter elements so that they are not pulled through the openings when the vacuum is released, or so that the filter elements are not sucked though the openings as the vacuum is applied.

FIG. 5 is a cross-sectional view of a centrifuge tube which includes a cover according to a third embodiment of the present invention. In order to protect the filter element 6 from accidental damage, a cover 11 can be provided. The cover 11 can be secured to the cap 2 in the same manner as the cap 2 itself is secured to the centrifuge tube body 3. Otherwise, the cover 11 can be a relatively flat element that is secured to the cap 2 by an adhesive. The cover 11 may also be permanently attached to the cap 2 and include a portion which can be torn-off and removed to expose the filter element 6 to allow air to vent through filter element 6 and through cap 2.

FIG. 6 is a cross-sectional view of a cap according to a fourth embodiment of the present invention. The cap 2 in FIG. 6 includes internal threads 12. This cap 2 can be secured to a centrifuge tube or bottle which includes cooperating external threads adjacent the open end thereof. Likewise, locking structures such as bayonet rings can be incorporated into the cap 2 and tube body 3.

The present invention is applicable to all types of vessels used for lyophilization, notably all types of capped test tubes, centrifuge tubes, vials, bottles, etc.

A multi-well plate can also be used for venting and/or drying multiple samples at one time via the above-described filter element. There are a variety of approaches for coupling filter elements to a multi-well plate. However, any configuration that provides a means for venting each well through the filter element should be suitable. It is also useful if the mechanism employed for coupling the filter elements to the multi-well plate also substantially prevents sample cross-contamination between the wells.

One approach involves providing a sheet defining a plurality of contiguous discrete caps for each well of the multi-well plate. The sheet may be made from a flexible or inflexible material. Each of the individual caps may carry or bear a filter element in a manner similar to that described above. Optionally, a filter element-bearing individual cap may be sufficiently large so that it encompasses a plurality of wells rather than just a single well. The filter element-bearing caps may be provided and used individually rather than as a sheet of caps. For example, the multi-well plate could be constructed so that a predetermined individual or groups of wells could be separated from the plate as needed. In this scenario, the individual associated filter element-bearing caps could be separated from the sheet of caps.

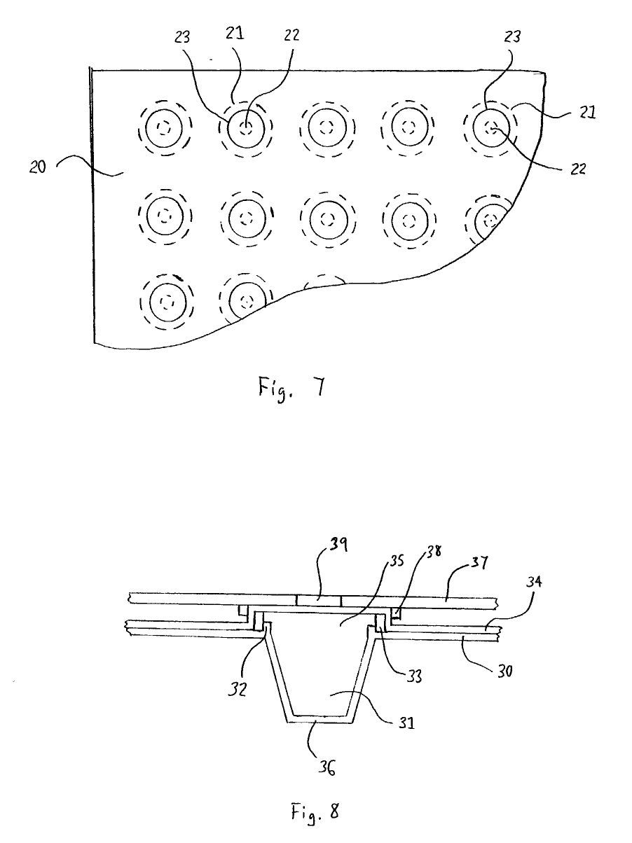

An illustration of a sheet of filter element-bearing caps is depicted in FIG. 7. FIG. 7 shows one corner of a sheet 20 that defines a first or top surface and an opposing second or bottom surface. A plurality of caps 21 are defined by the bottom surface. Each cap 21 is formed by an annular protrusion extending from the bottom surface of the sheet. The length and circumference of the protrusion is sufficient to fit securely to or over the outer circumference of the well on a multi-well plate. The cap defines at least one opening 22. A plurality of openings (not shown) may be provided for each well similar to the tube cap shown in FIG. 3. The opening 22 is covered by a filter element 23. As discussed above, the filter element 23 can be provided on either the upper or lower surface of the cap 21 as long as it extends across the opening 22: Alternatively, the filter element 23 can be provided within opening 22. The sheet 20, the caps 21, and the filter elements 23 may be constructed from the same material as described above in connection with the centrifuge tube.

The filter element 23 can be secured to the cap 21 by an adhesive or a cement. Alternatively, the filter element 23 can be secured to the cap 21 by a welding method such as heat welding, radio frequency welding or ultrasonic welding. It is also possible to secure the filter to cap 21, or in the opening 22 of the cap 21, by means of a mechanical element such as a retaining ring or recess, to which, or by which, the filter element 23 is attached to the cap. For example, a support ring or ledge could be provided in the bore of the opening 22 and the filter element 23 could be secured either directly to the support ring or the filter element could be secured to the support ring by a retaining ring.

The sheet 20 could be placed adjacent to the surface of the multi-well plate defining the well openings so that each cap is aligned with an individual well. Force can then be applied to the sheet 20 so that at least a plurality, and substantially all, of the caps 21 are simultaneously releasably engaged with the well openings. The well openings may be provided with an annular lip protruding from the surface of the multi-well plate that can engage with the cap 21 in a manner similar to that described above in connection with FIGS. 1 and 2. Alternatively, an annular shoulder may be defined around the inner surface of the well opening to receive the cap 21. A substantially air-tight seal should be formed between the cap and the well opening so that the only pathway for air to enter the well and contact the sample is through the filter element.

In another approach, the filter element is a continuous filter sheet positioned adjacent to a surface of the multi-well plate defining the well openings. An illustration of this approach is depicted in FIG. 8.

A multi-well plate 30 is provided that includes a plurality of wells 31. Each well defines an opening 35 and a bottom surface 36. Well geometries alternative to that shown in FIG. 8 can also be used. FIG. 8 depicts only a single well 31, but the same configuration could be provided for a plurality of wells. A circumferential wall 32 is provided around the rim of the well opening. An O-ring 33 is disposed around the peripheral surface of the circumferential wall 32. After a sample of interest is introduced into the well 31, a filter sheet 34 is placed over the top surface of the multi-well plate 30 so that it covers the well opening 35. A cover 37 that defines a gasket 38 and at least one opening 39 then is placed over the filter sheet 34 so that the gasket 38 and opening(s) 39 are aligned, respectively, with the O-ring 33 and the well opening 35. The opening(s) 39 provides venting into and/or from the well opening 35 via the filter sheet 34. Alternatively, the opening(s) 39 in the cover 37 could hold a filter element, thus, eliminating the need for the filter sheet 34. The circumference of the gasket 38 is complementary with the circumference of the well O-ring 33 so that a secure fit is created that prevents cross-contamination between samples in different wells. Force is applied to the cover 37 and/or multi-well plate 30 so that the gasket 38 and O-ring 33 releasably engage each other with the filter sheet 34 disposed between the gasket 38 and the O-ring 33. A substantially air-tight seal should be formed by the gasket 38 and O-ring 33 so that the only pathway for air to enter the well and contact the sample is though the filter sheet 34. The multi-well plate 30, filter sheet 34, and cover 37 may be constructed from the same material as described above in connection with the centrifuge tube.

A further variant for coupling the filter element to a multi-well plate contemplates attaching the filter element to the plate itself. Typically, the filter element would be positioned within, at, or near the well opening (e.g., within about 2 mm of the well opening). The filter element may pivot or completely release from the multi-well plate for introducing the sample into the well. For example, each well may include a filter element pivotally mounted at the well opening. Pivotal mounting could be accomplished, for example, by affixing a hinge mechanism to the multi-well plate surface near the opening and to the surface of the filter element facing away from the well opening (i.e., the top surface of the filter element).

When using the centrifuge tubes or multi-well plates of the present invention during a sterile lyophilization process, as the vacuum is terminated after lyophilization, air which is drawn into the centrifuge tube or multi-well is filter-sterilized. That is, contaminants such as microbes, dust, and other unwanted materials are retained by the filter element so that they do not enter the centrifuge tube or plate wells.

A device of the present invention can be used to dry materials used in microbial, tissue, organ, or plant culture, such as proteins, peptides, nucleic acids, etc., especially where a small volume is to be divided into smaller aliquots for storage. Such aliquots (e.g. 50 microliters) are difficult to filter-sterilize, so that filter-sterilization is best done prior to aliquoting and lyophilization.

In a typical sterile lyophilization procedure, according to the present invention, a compound of interest, e.g. a protein, peptide, nucleic acid, etc., in solution is placed in a container of the invention. For example, a sample may be pipetted into the multi-well plate. The centrifuge tube is sealed with a cap having a filter element incorporated therein as described above, and placed in a centrifugal apparatus such as the Speed-Vac®. Similarly, the multi-well plate is sealed with caps or covers as described above, and placed in a centrifugal apparatus such as a Speed-Vac® that is commercially available from ThermoSavant.

A vacuum of approximately 50 to 500 milli·Torr is applied to the compound as the compound is centrifuged. The high vacuum causes some of the liquid in the solution to gasify and leave the solution. This phase change removes heat from the solution and tends to cause freezing simultaneously with drying of the material. As discussed above, the centrifugal force of the centrifuge tends to keep the liquid phase at the bottom of the centrifuge tube or well so that it does not jet out with the gasified portion of the solution.

After lyophilization is complete, the vacuum is turned off and ambient gas, such as air or an inert gas, is drawn into the centrifuge tube or well through the filter element in the cap. Passage of the ambient gas through the filter element causes filter-sterilization of the ambient gas and thus prevents contamination of the lyophilized compound.

As is apparent from the above discussion, a key advantage of the present invention is that it permits one to perform many operations sequentially in the same container. In particular, some or all of the following steps can be performed in a single tube or bottle:

(1) A sample can be aliquotted into the container;

(2) The container can be sealed, with gases passing through the filter means and possibly passing around the cap between its interface with the container body (as long as microbes cannot pass between the cap and container body);

(3) The sample can be dried, with or without lyophilizing;

(4) The sample can be vented to the external environment;

(5) The sample can be lyophilized, including applying a vacuum and centrifuging;

(6) The sample can be stored in the same container, e.g., in a freezer;

(7) A dried sample can be dissolved or reconstituted in the container, using water or other solvents;

(8) The sample can be agitated in the container to mix the components therein, which procedure usually deposits material on the inner walls of the container;

(9) The sample can be centrifuged in order to force components on the walls back down to the bottom of the container;

(10) Should particulate material form, e.g., when a protein becomes denatured, the centrifuging step gathers the particulates together which assists in future handling, e.g., by not clogging a pipette;

(11) The sample can be removed from the container for subsequent use; and

(12) If sample is left over, it can be relyophilized and the previous steps can be repeated.

In addition to aseptically drying material, the multi-well plate may be used for aseptically culturing samples. A researcher or technician often grows many different cultures simultaneously. In order to grow different purified cultures simultaneously, the researcher or technician may grow one selected culture per well and the filter element would permit the passage of gases necessary for culture growth but prevent the introduction of any contaminants. The multi-well plates also can be used when treatment, analysis, reaction, derivatization, or some other manipulation of the culture in the well is desired. By way of illustration, a method for culture growth and processing in a multi-well plate that includes filter element-bearing caps is described below.

In particular, growth medium may be pipetted into the wells using a multi-channel pipettor. The well then can be inoculated with various bacteria. The filter element-bearing caps are then placed over all bacteria-containing wells. The bacteria can be incubated in the multi-well plate, with or without shaking. After incubation, the multi-well plate may be centrifuged causing the bacteria to form a pellet at the bottom of each well. The caps are then removed to withdraw the supernatant liquid. A reagent may then be added for any purpose to the bacterial pellets in wells, the filter element-bearing cap is placed back over the well, and the multi-well plate subjected to any desired processing conditions.

The presently described multi-well plate allows one to purchase biological materials in bulk that can then be sterilized in bulk via known techniques such as ultra-filtration. The sterilized bulk material then can be aliquotted and freeze-dried in sterile aliquots using the multi-well plate without clean-room facilities or sample loss due to sterile filtration of individual aliquots. Aliquotting of sterile samples could be accomplished more quickly using the multi-well plate since individual sterilization is not required and multi-channel pipettors are available for aliquoting the bulk-sterilized material into all the wells of the plate in a single action that takes only a few seconds.

In addition, the multi-well plates are less expensive and more convenient to use than centrifuge tubes. For example, a plate with 96 wells occupies less space and is less expensive compared to 96 centrifuge tubes.

A further feature of the multi-well plates is that after the desired drying and/or culture growth has been completed the multi-well plates can be sealed by placing a cover or lid over the filter openings. The sealed multi-well plates then can be stored until use.

Although the present invention has been described with reference to particular examples, one skilled in the art will appreciate that certain changes and modifications of the invention as set forth in the appended claims can be practiced without departing from the spirit and scope of the invention.

What is claimed is:

1. A method of venting samples contained in a multi-well plate, comprising:
providing a multi-well plate that includes a plurality of wells that contain a sample that includes vaporizable material, each well defining an opening substantially sealed with a filter element, the filter element permitting permeation therethrough of at least one gas and substantially preventing permeation therethrough of microbes; and
permitting gas to enter or exit the wells by permeating through the filter element, thereby affording venting of the samples without substantially contaminating the samples with microbes.

2. The method of claim 1, further comprising substantially sealing the opening with a filter element-bearing cap or filter element-bearing cover.

3. The method of claim 2, wherein the sealing includes coupling the cap or cover with the multi-well plate so as to substantially prevent microbes from passing between the cap or cover and the multi-well plate.

4. The method of claim 1, wherein providing the samples in the wells comprises:
inserting one channel of a multi-channel pipettor at least partially into the well through the opening; and
providing at least a portion of the sample through the pipettor and into the well.

5. The method of claim 1, further comprising culturing the samples in the multi-well plate simultaneously with the venting of the samples.

6. The method of claim 1, wherein the filter element does not permit substantial permeation therethrough of materials having a diameter greater than about 0.2 microns.

7. The method of claim 1, wherein at least a plurality of the well openings are simultaneously sealed.

8. The method of claim 7, wherein substantially all of the well openings are simultaneously sealed.

9. The method of claim 7, wherein the sealing comprises sealing the opening with a filter element-bearing cap or filter element-bearing cover.

10. The method of claim 9, further comprising providing a sheet that defines a plurality of filter element-bearing caps.

11. The method of claim 1, wherein the filter element comprises a filter sheet and the sealing comprises positioning the filter sheet adjacent to a plurality of openings and then sealingly engaging the filter sheet with the openings.

12. A method of drying solid or liquid samples contained in a multi-well plate, comprising:
providing a multi-well plate that includes a plurality of wells that contain a sample that includes vaporizable material, each well defining an opening, which opening is substantially scaled with a filter element, which filter element permits permeation of the vaporizable material therethrough and substantially prevents permeation of microbes therethrough; and
permitting at least a portion of the vaporizable material to permeate the filter element, thereby affording at least a partial drying of the samples without substantial microbial contamination thereof.

13. The method of claim 12, wherein the samples are simultaneously subjected to centrifuging and a vacuum so as to at least partially lyophilize the samples.

14. The method of claim 12, further comprising substantially sealing the opening with a filter element-bearing cap or filter element-bearing cover.

15. The method of claim 12, wherein the filter element does not permit substantial permeation therethrough of materials having a diameter greater than about 0.2 microns.

16. The method of claim 14, further comprising providing a sheet that defines a plurality of filter element-bearing caps.

17. A method of venting samples contained in a multi-well plate, comprising:
introducing a sample into a well of a multi-well plate via an opening defined by the well;
covering at least a portion of the well opening with a filter element that is secured to the multi-well plate; and
permitting gas to enter or exit the well substantially only through the filter element during drying or processing of the samples.

18. The method of claim 17, further comprising bulk sterilizing a material and then aliquotting samples of the bulk-sterilized material into the wells of the multi-well plate.

19. The method of claim 17, wherein covering at least a portion of the well opening with a filter element comprises engaging the multi-well plate with a sheet defining a plurality of filter element-bearing caps.

20. A multi-well plate assembly that can be placed in a centrifuge, comprising:
a multi-well plate defining a plurality of wells, each well defining an opening and an interior volume; and
a sheet defining a plurality of caps, each of the caps including a microbe-impermeable filter element that can allow gas flow into the interior volume from external the multi-well plate and that can allow gas flow out from the interior volume.

21. The assembly of claim 20, wherein the assembly is capable of withstanding centrifuging at about 50 or more times the force of gravity.

22. The assembly of claim 20, further comprising a cover placed on the caps for protecting the filter element.

23. The assembly of claim 20, wherein each cap defines an annular protrusion extending from a surface of the sheet.

24. The assembly of claim 23, wherein each well opening includes an annular lip extending from a surface of the multi-well plate that can engage with the annular cap protrusion.

25. The assembly of claim 20, wherein each cap defines at least one opening across which the filter element extends.

26. The assembly of claim 25, wherein each cap defines more than one opening.

27. The assembly of claim 20, wherein the filter element comprises a membrane filter.

28. The assembly of claim 20, wherein the filter element is secured to the cap with an adhesive, a cement, a welding, or a mechanical fastening.

29. The assembly of claim 20, wherein the filter element has a pore size of less than about 22 μm.

30. A multi-well plate assembly, comprising:
a multi-well plate defining a plurality of wells, each well defining an opening for receiving a sample; and
a filter positioned to extend across at least a portion of the well opening, wherein the filter is microbe-impermeable and gas permeable.

31. The assembly of claim 30, wherein the filter comprises a filter sheet that covers a plurality of well openings.

32. The assembly of claim 30, wherein the filter comprises a filter element positioned within about 2 mm of the well opening.

33. The assembly of claim 31, wherein the multi-well plate includes a first surface defining the well openings, the filter sheet includes a first surface and an opposing second surface, and the first surface of the filter sheet is adjacent the first surface of the multi-well plate, the assembly further comprising a cover adjacent the second surface of the filter sheet, wherein the cover defines at least one opening aligned with the well opening.

34. The assembly of claim 33, further comprising a sealing sub-assembly positioned at the well opening.

35. The assembly of claim 34, wherein the sealing sub-assembly includes at least one member selected from an O-ring and a gasket.

36. The assembly of claim 30, wherein the filter comprises a membrane filter.

37. The assembly of claim 30, wherein the filter has a pore size of less than about 22 μm.
